(19) United States
(12) Patent Application Publication
(10) Pub. No.: US 2011/0131006 A1
(43) Pub. Date: Jun. 2, 2011

(54) PROGRAMMABLE SYSTEM FOR CHECKING MECHANICAL COMPONENT PARTS

(76) Inventors: Andrea Ferrari, Ferrara (IT); Giancarlo Perroni, Modigliana (IT)

(21) Appl. No.: 12/674,865

(22) PCT Filed: Aug. 27, 2008
(86) PCT No.: PCT/EP08/61217

§ 371 Date: Feb. 23, 2010

(30) Foreign Application Priority Data
Aug. 30, 2007 (IT) BO2007A000596

(51) Int. Cl. G06F 15/00; G01B 5/02

(52) U.S. Cl. 702/150; 702/155

(57) ABSTRACT

A system for checking dimensions of mechanical component parts includes a checking probe (4) which can be programmed from a base unit (11) by means of a wireless radio-frequency link. An interface unit (34) connected to or integrated in the base unit includes control devices with at least an infrared receiver (26, 27) causing the generation of a control signal once coded signals are received. The coded signals can be transmitted by a remote controller (37)—which can be of a universal or dedicated type—or by an emitter (24, 25) adjacent to the receiver. In this second case the transmitted coded signal is adapted to be reflected, for example by an operator's finger, and the pair of emitter and receiver forms an optical switch.

### TECHNICAL FIELD

The present invention relates to a system for checking the position and/or dimensions of mechanical pieces, including a checking probe with detecting devices, power supply devices, processing circuits, and at least one remote transceiver unit for the wireless transmission and reception of signals, a base unit for the wireless transmission and reception of signals to and from the remote transceiver unit, display devices, and an interface unit connected to the base unit and comprising control devices.

### BACKGROUND ART

There are known systems and methods, that are utilized for example in numerical controlled machine tools, employing contact detecting probes mounted on the machine for determining the position and/or the dimensions of the machined pieces. In the course of the checking cycle, one of such probes moves with respect to the piece, touches the surface to be checked and wirelessly transmits the signal indicative of the contact to a base unit, which is typically located spaced apart from the probe. The base unit is, in turn, connected to a numerical control unit which processes the signals sent by the probe.

The contact detecting probe can include electric batteries for the power supply of the contact detecting circuits and of the circuits for the wireless transmission of the signal by means of an electromagnetic wave of the optical or radio-frequency type. As the probe is utilized just for short intervals during the machining cycle of the associated machine tool, the contact detecting circuits and transmission circuits of the former are normally kept in a low power consumption state, and are fully powered-up only when there is the need to perform a checking cycle, i.e. a contact detection and transmission; this has the purpose of extending battery life as long as possible. The switching from the low power consumption state to the normal operational condition can take place by means of suitable signals, wirelessly transmitted from the base unit. When the checking cycle ends, the probe circuits return to the low power consumption state either further to an explicit message wirelessly sent from the base unit, or, as an alternative, after the elapse of a predetermined time period. This time period can be calculated since the beginning of the checking cycle or, as an alternative, since the last contact signal of the probe.

Should there be more than one probe operating in the same working area, as frequently occurs, there can be necessary to foresee the possibility of selecting one probe among a plurality of probes.

In general, each probe is characterized by the value assumed by some parameters, as, for example, those relating to the transmission frequency (in the case of transmission by means of radio-frequency signals), to the probe identification, to the operation/switching off time, to the calculation mode of a timing generator or switching off timer. As an alternative, some parameters that are not essential for the transmission can be stored in the base unit. For instance, the operation/switching off time can be stored in the base unit so that, upon elapse of the predetermined time period, a suitable control, wirelessly sent, brings the probe to a low power consumption state. Moreover, it could be necessary that the base unit stores some parameters relating to its operation. For example, if the outputs towards the numerical control are implemented by means of a solid state relay (SSR) it is generally useful to programme whether the rest condition corresponds to a closed output (NC: normally-closed) or an open output (NO: normally-open). Another parameter to be stored can be for example the transmission frequency (in the case of transmission by means of radio-frequency signals). Other parameters can be stored and employed as well.

In the known systems, the values of the different parameters are defined and stored in the probe and in the base unit by means of memory devices, that can be programmed with different methods and are typically activated upon assembly in the associated machine. It is possible, for example, to employ mechanical microswitches housed in the probe and in the base unit, or to use push buttons located in the probe for programming the probe and push buttons and symbolic viewers or displays located in the base unit for programming the base unit. Moreover, the probe parameters can be wirelessly programmed by employing an optical or radio-frequency electromagnetic signal sent to the probe by means of suitable transceiver systems. In this case the very push buttons and displays located in the base unit can be utilized for programming the probe, as disclosed for example in the international patent application published with No. WO-A-2005/013021.

The solutions that are currently used for programming probes have various limits. The employ of mechanical microswitches placed in the probes not only makes the latter more complex in terms of manufacturing and thus bulky, but may also affect the battery consumption. Moreover, in the event the parameters should be changed after the installation, the probe must be removed. On the other hand, the employ of a programming push button placed in the probe has some limits. In fact, by means of such push button and using as a feedback light emitting diodes (LEDs) located in the probe, two different operations must be performed, that is “streaming” the values of pre-defined sequences and selecting the desired options: in the case of complex parameters, such as, for example, the setting of the frequency transmission, the operations could be very onerous for both the user's undertaking and the battery consumption. In this case, the insertion of a display in the probe for facilitating programming operations causes increased costs in terms of consumption and space. These aspects are improved in solutions including a remote programming by means of the base unit, such as, for example, the solution described in the hereinbefore mentioned international patent application published with No. WO-A-2005/013021. The known solutions don't have any particular problems when the base unit, or part of the base unit, is arranged at a position which doesn't need a wet seal and could be easily reached by the operator, such as, for example, within the machine cabinet or near the numerical control panel.

However, it is often needed that the transceiver unit of the base unit is located within the working area of the machine so that the wireless connection is reliable. Hence, the base unit must be wet sealed, can be subjected to dirt and can be hardly reached by the operator.

### DISCLOSURE OF THE INVENTION

Object of the present invention is to provide a system which does not have the same problems of the known systems and wherein the values of the programmable parameters characterizing each probe and base unit can be modified in a simple and reliable way.

This and other objects and advantages are achieved by a checking system according to claim 1, or claim 16 or claim 23.

### BRIEF DESCRIPTION OF THE DRAWINGS

The invention is now described with reference to the enclosed sheets of drawings, given by way of non limiting examples, wherein:

FIG. 1 shows, in a simplified way, a checking system according to the present invention;

FIG. 2 is a block diagram of the circuits associated to the base unit of FIG. 1;

FIG. 3 shows the structure of a possible remote controller for programming the system according to the present invention; and

FIGS. 4 and 5 are flow-charts showing a possible programming cycle.

### BEST MODE FOR CARRYING OUT THE INVENTION

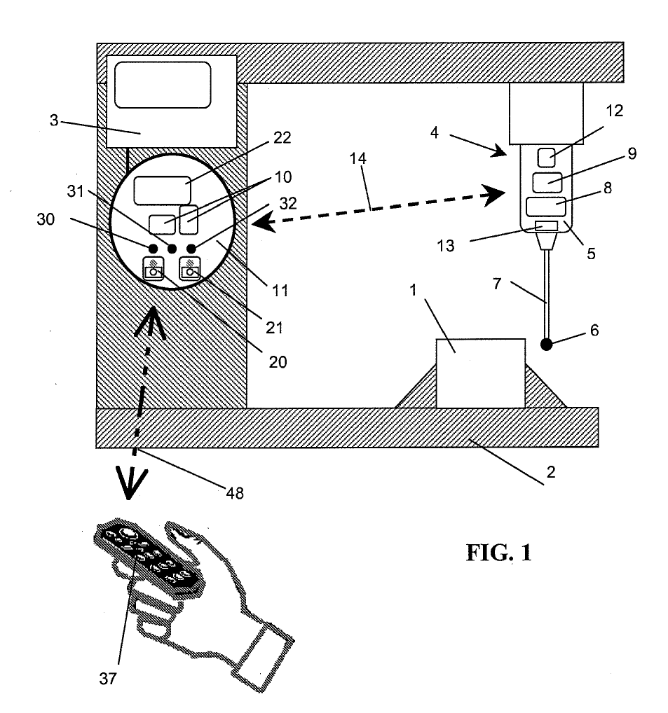

FIG. 1 illustrates, in a simplified form, a system for detecting linear dimensions of a piece 1 in a machine tool, for example a machining centre, schematically shown in FIG. 1 and identified with reference number 2. The system includes a computer numerical control 3, which superintends the operation of the machine tool 2, a detecting apparatus including a checking probe 4, and a base unit 11, with an integrated interface (as it will be hereinafter described) connected to the numerical control 3 by wire. The checking probe 4, for example a contact detecting probe, has a support and reference portion 5, connected to the slides of the machine tool 2, a feeler 6 and an arm 7 which carries the feeler 6 and is movable with respect to the support and reference portion 5. Moreover, the probe 4 includes detecting devices, for example a microswitch 13, power supply devices 12 including a battery, one (or more) remote transceiver unit 8 for remotely and wirelessly transmitting and receiving signals, to and from the base unit 11, and processing circuits, such as, for example, logic or memory units, that are schematically shown in FIG. 1 and indicated with reference number 9. The type of the processing circuits 9, that can be implemented in different ways and can be employed, among other things, for programming the parameters of the probe 4, is not herein outlined in detail and reference can be made to the already mentioned patent application published with No. WO-A-2005/013021 for a more detailed description. The base unit 11, preferably stationary, includes, in turn, one or more transceiver devices 10 for communicating with the probe 4. The remote transceiver unit 8 and the transceiver device/s 10 of the base unit 11 define a single wireless two-way communication link 14, for example for a radio-frequency transmission on a single channel, or for the transmission of information by means of optical or acoustic signals or wireless means according to a different technology. The transceiver devices 10 of the base unit 11 serves to send, further to a request sent by the computer numerical control 3 and, for example, through the radio-frequency channel, coded signals to the remote transceiver unit 8 of the probe 4 for requesting to bring the probe 4 to normal operational conditions or to a low power consumption state. The transceiver devices 10 also serve to receive from the remote unit 8 of the probe 4 coded signals, for example of the radio-frequency type too, that can indicate the position in the space of the feeler 6 with respect to the support 5, the charge level of the battery 12 of the probe 4, the identity of the probe 4 in the case of a selective actuation, or other information.

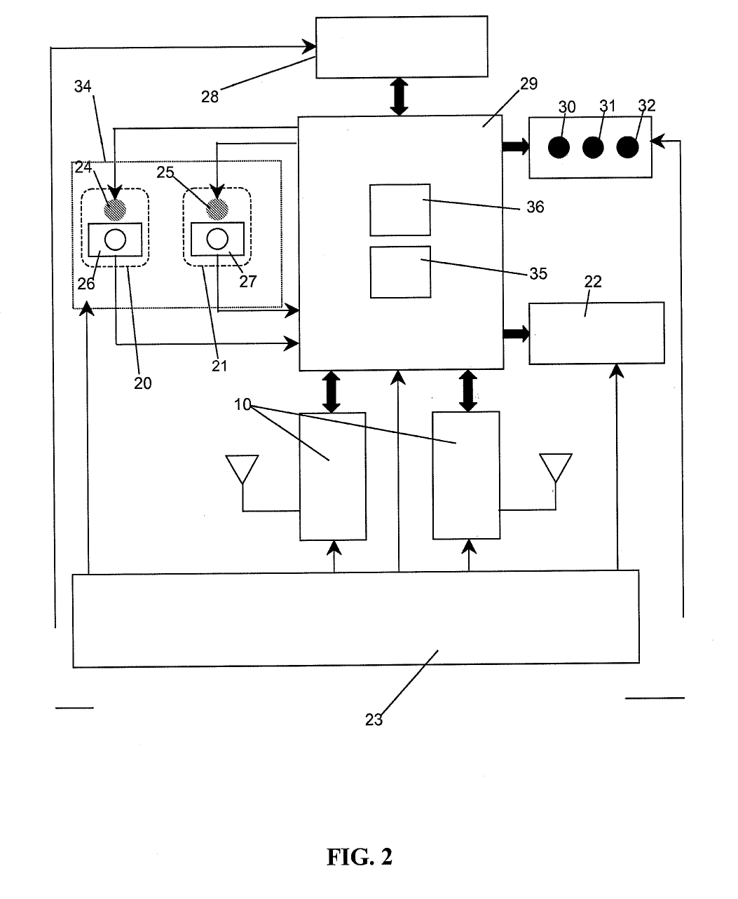

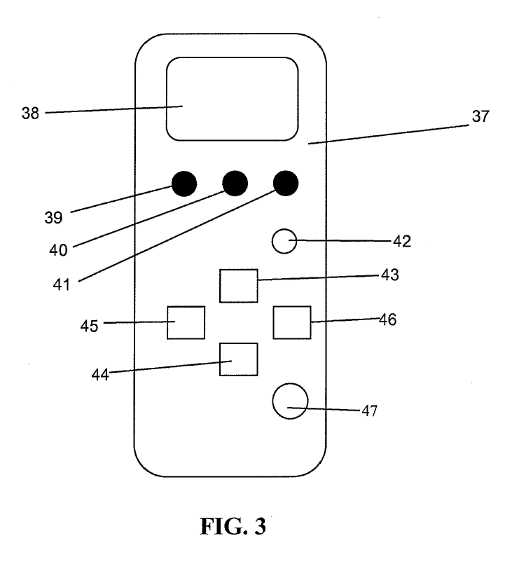

An interface unit 34 (visible in FIG. 2 in more detail) having a high sealing degree and connected to the base unit 11, preferably but not necessarily integrated with the latter, includes one or more control devices. Two of such control devices, i.e. two transceivers, preferably infrared transceivers 20 and 21, are shown in FIG. 1. Such control devices can act as contactless switches, in particular optical switches, for transmitting radiations and detecting reflections caused by an approaching object, for example the operator's finger. The same control devices 20 and 21 can, as an alternative, detect commands given by means of an infrared remote controller 37, which can be dedicated or of the universal type. Signals caused by detection of, either the reflections or the above-mentioned commands, are sent by the control devices 20 and 21 to a logic unit 29 as it will be hereinafter illustrated. The interface unit 34 can further include indication devices such as for example a symbolic viewer or display 22 and/or light emitting diodes 30,31,32 that could also provide different indications in different operation conditions (state and power supply of the probe 4 or an error under normal operational conditions, “select” and “enter” in programming phase . . . ). The dedicated remote controller 37 (FIG. 3) can comprise these indication devices, as it will be hereinafter disclosed.

The general structure of the circuit component part of the base unit 11 of the system is shown in FIG. 2. The previously mentioned logic control unit 29 (for example a microcontroller) superintends and manages all the activities of the base unit 11. The logic control unit 29 is a programmable unit including registers 36 and a non-volatile memory 35 that enable to permanently store programming data and parameters. A further external memory 28, for example an EEPROM, can be included. The logic unit 29 communicates with the interface unit 34 for receiving signals and generating controls relating to the system programming (of the base unit 11 and/or the probe 4) and can display various information by means of suitable display devices such as for example the previously mentioned display 22 and/or the light emitting diodes 30,31,32. FIG. 2 also shows two of the already mentioned transceiver devices 10 that, during the reception phase, i.e. when the base unit 11 is set for receiving signals, can both operate for compensating possible problems due to multiple paths. On the contrary, during the transmission phase, i.e. when the base unit 11 is set for transmitting signals, the transceiver devices 10 can operate only one by one, one excluding the other. All the elements of the base unit 11 are fed by a suitable power supply system 23.

The interface unit 34 includes, as previously stated, infrared transceivers 20 and 21, i.e. pairs 24-25 and 26-27 of receivers (26 and 27, for receiving infrared signals) and emitters (24 and 25, for emitting infrared signals). The transceivers 20 and 21 define—as already stated—two contactless switches, in particular optical switches. The respective emitters 24 and 25, for example infrared diodes, generate and radiate a coded infrared signal: if an obstacle, for example an operator's finger, approaches one or both the optical switches, the infrared signal radiated by the emitters 24 and 25 is reflected and then detected by the receivers 26 and 27, so realizing a condition of “pressed key”. Such a condition causes the logic unit 29 to generate a control signal which can be utilized for programming the base unit 11 and/or the probe 4 and can be signalled by means of the display devices located in the base unit 11 (the display 22 and/or some light emitting diodes, for example the diodes 30 and 32) with the purpose of informing the operator that a key has been pressed. The display 22 indicates the parameter which is being set (for example: transmission channel) and its value as well. The display devices can be also used, under normal operational conditions and beyond the programming scope, for signalling, for example, that the contact between the feeler 6 and the piece 1 has occurred, or the battery in the probe 4 is almost exhausted, or the wireless linking between the base unit 11 and the probe 4 is down, or other information.

According to a different operating mode of the system, one of the infrared receiver (for example the receiver 26) is used for receiving a command consisting in a coded signal which is provided by the remote controller 37 through a second wireless link 48. In this case the display devices can be those, already mentioned, located in the base unit 11 (display 22/LEDs 30,31,32) or a display 38 and some LEDs 39,40,41 placed in the remote controller 37.

The operation of the checking system is generally per se known. Briefly, further to the contact between the feeler 6 of the probe 4 and the surface of the piece 1 to be checked, the microswitch 13 detects displacements of the arm 7 and generates a detecting signal which is processed and transmitted from the remote unit 8 to the transceiver devices 10 of the base unit 11 through the wireless link 14.

The programming phase of the probe can be performed as disclosed in the previously mentioned international patent application published with No. WO-A-2005/013021. With reference to the system illustrated in such patent application, the control devices including the keys of the interface unit are replaced by the transceivers 20 and 21 of the base unit 11, or by the respective receivers 26 and 27, or by at least one of such receivers, the activation mode thereof will be hereinafter described.

Insofar as the operation of the interface unit 34 is concerned, the two emitters 24 and 25 emitting infrared beams can be driven by the logic unit 29 by means of suitable coded signals, the power thereof can be possibly set by means of suitable generation techniques.

When a reflecting body, for example an operator's finger, approaches one or both the optical switches 20 and 21, the receivers 26 and 27 provide in response a signal which can be read by the logic unit 29, and the latter can thus detect that one or both the switches 20 and 21 have been “pressed”.

For the purpose to avoid false signalling due to casual passing of solid bodies or dirt deposit in front of the optical switches 20 and 21, it is possible to carry out a self-calibrating cycle, thanks to the possibility of setting the signal power of the emitters 24 and 25 as it will be hereinafter briefly described. It is possible to use other techniques for avoiding false signalling, for example on the basis of a minimum time interval in the course of which the receivers 26 and 27 detect a stable coded signal.

As already mentioned, since the accumulated dirt in front of the switch panel can increase and thus cause a gradual lowering of the standards of performance of the switches 20 and 21, it is possible to periodically carry out self-calibrating, or zero-setting, cycles. For this purpose, the logic unit 29 can be programmed so as to actuate at regular intervals—for example when the interface unit 34 is not used for programming and the probe 4 is in a low consumption state, or sporadically during the programming cycles—a calibrating procedure enabling to define and re-define an amount of signal power which is sufficient for driving the emitters 24 and 25 so as to cause that the sensitivity of the switches 20 and 21 to the “pressure” remains unchanged over time as much as possible. This gauging can be carried out, for example, by detecting each time the power maximum value of the emitted infrared beam beyond which the receivers 26 and 27 detect the reflection of such signal caused by a simple transparent or semitransparent covering (such as the protective glass) placed on the base unit 11.

As already mentioned, according to a different operation mode of the system, the logic unit 29 is programmed so as to be able to recognise—by means of at least one infrared receiver (for example the receiver 26) not only the signal provided by the emitters 24 and/or 25 (and properly reflected) but also a coded signal emitted by the remote controller 37 and transmitted through the second remote link 48. The remote controller 37 can be a commercial device—as the remote controllers associated to common household appliances or so-called universal type remote controllers—or a dedicated or “customized” device, as that one shown in FIG. 3. With reference to such figure, assuming that the programming tree of the system includes a main menu enabling to have access to various submenus for parameters definition, it is possible to use the following matching between the keys of the remote controller 37 and associated functions in the system:

key 42: enter/esc from the programming phase (ON/OFF)

key 43: forward selection (select +)

key 44: backward selection (select −)

key 45: menu esc (enter −)

key 46: menu enter (enter +)

key 47: on-line help.

In particular, in the illustrated example and according to a programming method substantially corresponding to what has been described in the previously mentioned patent application published with No. WO-A-2005/013021, the forward selection key 43 and backward selection key 44 are used to cause commands relating to displacements among the different submenus of the main menu and to the selection of the wanted value among a sequence of possible values for a certain parameter (which could be either a numerical value among many values or an option between two or more options such as the choice of a normally-open output or a normally-closed output or yes/no type response to a request). On their turn, the menu enter key 46 and menu esc key 45 serves to cause controls relating to forward and backward displacements within a submenu of the main menu (implicitly confirming the parameter value displayed in the display) or to enter a submenu of the main menu.

At the end of a programming cycle (which can be carried out either using the remote controller 37 or acting on the contactless switches 20 and 21) it is possible to request an explicit updating confirmation of the parameter values, in a per se known way.

The ON/OFF key 42 serves to start or end the programming phase, whereas the key 47 is optional and serves to display on a suitable device, such as for example the display 22 or the display 38 integrated in the remote controller 37, help information about the current programming phase.

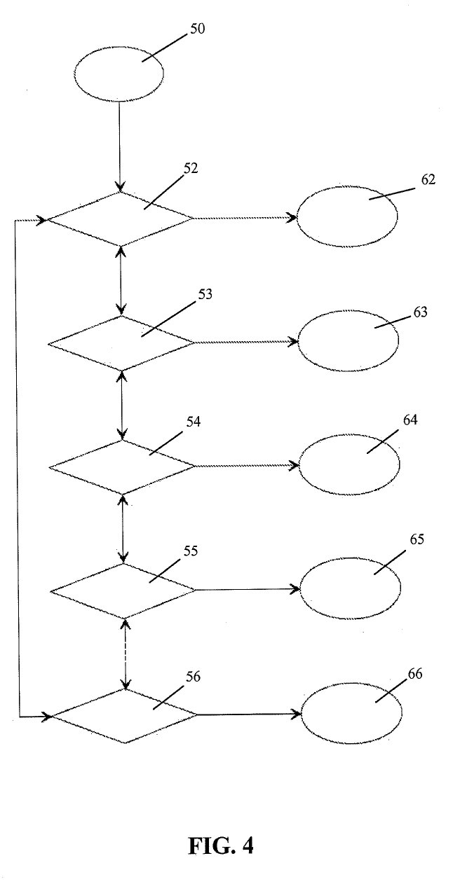

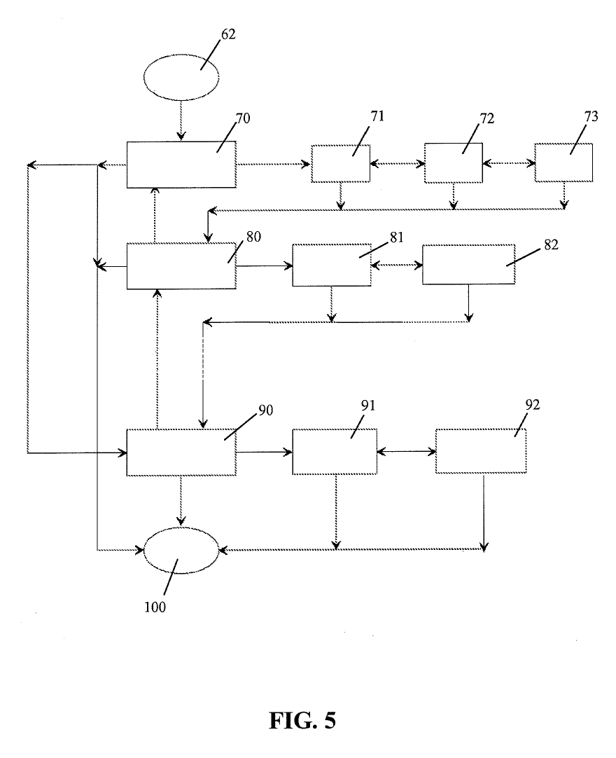

Possible steps carried out by means of the remote controller 37 are shown, just as an example, in the flow-charts of FIGS. 4 and 5 referring to a main menu and a submenu, respectively.

In FIG. 4, block 50 indicates starting of the operation by means of the ON/OFF key 42. Blocks 52-56 indicate different submenus selections that can be sequentially displayed by acting on the forward and backward selection keys 43 and 44, while blocks 62-66 indicate the corresponding submenus. More specifically the submenu selections and corresponding submenus according to the example of FIG. 4 are:

52/62—programming the base unit 11;

53/63—programming the probe 4;

54/64—activating the probe 4;

55/65—linking the probe 4 to the base unit 11; and

56/66—restarting the system.

Additional submenus and relevant selections can be provided for, as indicated by the partly broken line between blocks 55 and 56.

In order to enter the submenu according to the currently displayed selection, menu enter key 46 is acted on.

For example, in order to program the base station 11, after having started the operation (by means of key 42), keys 43 and 44 are acted on until selection 52 is displayed. Then, key 46 is pushed to enter the submenu 62 to which the flow chart of FIG. 5 refers.

In FIG. 5, blocks 70 and 80 indicate different parameters while blocks 90 and 100 refer to the updating confirmation that is mentioned above and to the end of the programming cycle, respectively. As an example, only two parameters are shown in FIG. 5, but they are generally more, as suggested by the partly broken lines between blocks 80, 81 and 82 and block 90. Parameters 70 and 80 (and additional ones) can be sequentially displayed by acting on the menu enter and esc keys 46 and 45. Blocks 71-73 and 81-82 indicate possible values for each of the (two) parameters and blocks 91 and 92 represent possible choices in connection with the updating confirmation.

More specifically, block 70 may, for example, indicate a maximum time interval in which a signal from the probe 4 can be expected, while block 80 may, for example, indicate the possibility of enabling or disabling the so-called (and per se well-known) “retrigger” of such maximum time interval, i.e. the re-start of counting such time interval at the receipt of a signal indicative of a change in the state of the probe 4. Blocks 71-73 represent a sequence of possible values for the interval of block 70. It is to be noted that only three blocks are shown, while the number of selectable values can be higher, as schematically indicated by the partly broken line between blocks 72 and 73. Blocks 81-82 represent the only two possible choices for the retrigger option: yes/enable (81) and no/disable (82).

In order to define the desired value for a parameter, for example the time interval, the relevant parameter (block 70) is selected by acting on the enter and esc menu keys 46 and 45, then the relevant value is chosen within the sequence of blocks 71-73 by acting on the forward and backward selection keys 43 and 44, and selection of such value takes place by means of key 46.

The next parameter(s), for example the retrigger option represented by block 80 and/or others that are not represented in the schematic flow chart of FIG. 5 are then programmed in the same way. It is underlined that the minimum number of values that may be selectable for each parameter is two, as in the example of blocks 81 and 82 (enable or disable), while it is not theoretically possible to establish a maximum number, since some parameters might assume many possible values.

Once values of all parameters are defined, a final confirmation may be asked for (block 90) and the possible choices are YES (block 91) or NO (block 90), such choices being selectable following the same procedure used for selecting the value of each parameter. If the YES choice is selected, the updated, selected values are stored, for example, in the non volatile memory 35 of base unit 11, while, if the “NO” is chosen, the programmation is aborted and, for example, all the updated, selected parameters values are deleted and original values are restored. After final confirmation (or abort) the programming cycle ends (block 100).

In case that the remote controller 37 include some indication devices, such as the already mentioned display 38 and/or light emitting diodes 39,40,41, the communication between the base unit 11 and the remote controller 37 is a two-way communication that can make use of the emitters 24 and 25 of FIG. 2.

A checking system according to the present invention enables to perform cycles for programming the parameters of the probe 4 by means of signals that are sent from the base unit 11 through the wireless two-way link 14 in per se known ways (for example according to what has been disclosed in the already mentioned international patent application published with No. WO-A-2005/013021, but also according to different methods and procedures). The system according to the present invention ensures a correct operation that is particularly reliable over time thanks to the presence of the contactless switches 20 and 21 which are completely located within the base unit 11 and don't have moving mechanical parts. In this way, it is possible to simply implement a wet sealed base unit 11 and arrange it in a suitable position within the working area. The possibilities of carrying out self-calibrations that have been previously disclosed further ensure the maintenance of the system performance over time.

In addition to the already mentioned programming operations of the probe 4, the system has the same advantages insofar as the programming of the parameters of the base unit 11 is concerned.

The use of at least one of the receivers 26, 27 of the transceivers 20, 21 for receiving a signal generated by a remote controller 37, dedicated or universal, enables the further important advantage of performing programming operations—of the probe 4 and/or the base unit 11—even in case that the base unit 11 is arranged in a position which the operator can hardly reach.

Moreover, the employ of an universal remote controller 37 enables to obtain remarkable advantages utilising a commercial object which is very common and involves low costs.

Checking systems according to the present invention can include embodiments differing from what has been herein so far described. For instance, it is possible to use a remote controller communicating through radio-frequency electromagnetic signals instead of infrared signals. In this case, and if, according to the preferred embodiment herein so far described, the base unit 1 communicates with the probe 4 through a radio-frequency link 14, the same transceiver devices 10 can be utilised to also receive the remote controller signals, that can be used for programming.

1. A system for checking the position and/or the dimensions of mechanical pieces including:
a checking probe with:
detecting devices,
power supply devices,
processing devices, and
at least one remote transceiver unit for the wireless transmission and reception of signals;
a base unit, for the wireless transmission and reception of signals to and from said at least one remote transceiver unit;
display devices; and
an interface unit connected to the base unit and including control devices with at least one transceiver.

2. The system according to claim 1, wherein the interface unit is integrated in the base unit.

3. The system according to claim 1, wherein said at least one transceiver includes a receiver adapted to receive coded signals and to cause the generation of a control signal once the reception has occurred.

4. The system according to claim 3, wherein said at least one transceiver further includes an emitter adapted to emit coded signals, said receiver element being adapted for receiving coded signals emitted by the emitter and reflected by an obstacle, and for consequently causing the generation of said control signal, so realizing a contactless switch.

5. The system according to claim 3, further including a remote controller adapted to emit coded signals, wherein said receiver is adapted for receiving coded signals emitted by the remote controller, and for consequently causing the generation of said control signal.

6. The system according to claim 5, wherein said remote controller is of the universal type.

7. The system according to claim 5, wherein said remote controller includes at least some of said display devices.

8. The system according to claim 1, wherein at least two transceivers are component parts of the control devices of the interface unit.

9. The system according to claim 1, wherein said checking probe and said base unit define a wireless single two-way communication link.

10. The system according to claim 9, wherein said at least one remote transceiver unit is adapted to transmit through said wireless single two-way link detecting signals generated within the checking probe by the detecting devices.

11. The system according to claim 1, for checking mechanical pieces in a grinding machine, wherein the checking probe is a contact detecting probe and the detecting devices include a microswitch.

12. The system according to claim 9, wherein said wireless single two-way link is of the radio-frequency type.

13. The system according to claim 1, wherein said at least one transceiver is an infrared transceiver.

14. The system according to claim 1, wherein said at least one transceiver is a radio-frequency transceiver.

15. The system according to claim 12, wherein said at least one transceiver is a radio-frequency transceiver device, and said single two-way link includes the radio-frequency transceiver device.

16. A system for checking the position and/or the dimensions of mechanical pieces including:
a checking probe with:
detecting devices,
power supply devices,
processing devices, and
at least one remote transceiver unit for the wireless transmission and reception of signals;
a base unit), for the wireless transmission and reception of signals from and to said at least one remote transceiver unit, the base unit and said at last one remote transceiver unit defining a wireless two-way link; and
an interface unit connected to the base unit and including control devices with at least one receiver, the system further including a remote controller adapted to transmit coded signals and to define a second wireless link including said at least one receiver.

17. The system according to claim 16, wherein said remote controller includes display devices, said second wireless link being a two-way link.

18. The system according to claim 16, wherein said wireless two-way link is of the radio-frequency type.

19. The system according to claim 16, wherein said second wireless link is an infrared optical link.

20. The system according to claim 16, wherein said second wireless link is a radio-frequency link.

21. The system according to claim 18, wherein the base unit comprises at least one radio-frequency transceiver device being part of the wireless two-way link, said at least one radio-frequency transceiver device including said at least one receiver.

22. The system according to claim 16, wherein said remote controller is of a universal type.

23. A system for checking the position and/or the dimensions of mechanical pieces including:
a checking probe with:
detecting devices,
power supply devices,
processing devices, and
at least one remote transceiver unit for the wireless transmission and reception of signals;
a base unit, for the wireless transmission and reception of signals to and from said at least one remote transceiver unit;
display devices; and
an interface unit connected to the base unit and including control devices with at least one receiver, and at least one emitter adapted for emitting coded signals, the system further including a remote controller adapted to emit coded signals, said at least one receiver being adapted to receive the coded signals which are emitted either by said at least one emitter and reflected by an obstacle, or by the remote controller, and to consequently cause the generation of a control signal.

24. The system according to claim 23, wherein said at least one emitter and said remote controller are adapted for emitting optical signals in the infrared range, said at least one emitter and said at least one receiver forming an optical switch.
